(19) United States
(12) Patent Application Publication
(10) Pub. No.: US 2007/0111007 A1
(43) Pub. Date: May 17, 2007

(54) Process for the preparation of coatings with specific surface properties

(76) Inventors: Uwe Wilkenhoener, Duesseldorf (DE); Martin Wulf, Langenfeld (DE); Carmen Flosbach, Wuppertal (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/593,267

(22) Filed: Nov. 6, 2006

Related U.S. Application Data
(60) Provisional application No. 60/736,422, filed on Nov. 14, 2005.

(51) Int. Cl. B05D 1/12; B05D 3/00; B32B 27/00

(52) U.S. Cl. 428/411.1; 427/532; 427/180

(57) ABSTRACT

A process for the preparation of powder coatings with a controlled surface appearance comprising the steps of applying a powder coating composition onto the substrate surface comprising 1 to 95 wt % of at least one hydrophobic agent, irradiating the applied powder coating composition with high energy radiation having a UV dose in a range of 100 to 5000 mJ/cm² under near-ambient temperature, fusing, melting and flowing out the particles of the powder coating composition by increased temperature to a molten coating, and curing the molten coating; the process according to the invention makes it possible to provide coatings with a controlled surface appearance as well as to provide coatings having a high mechanical and outdoor stability without a change in formulation of the powder coating composition.

### CROSS-REFERENCE TO RELATED APPLICATION

This application claims the benefit of U.S. Provisional Application 60/736,422, filed Nov. 14, 2005, which is hereby incorporated by reference in its entirety.

### FIELD OF THE INVENTION

The invention relates to a process of preparation of a controlled surface appearance of powder coated substrates by using powder coating compositions curable with high energy radiation.

### DESCRIPTION OF RELATED ART

Powder coatings which can be cured by high energy radiation, such as, ultraviolet (UV) light have been under development for many years. Typically, these compositions contain a binder resin with ethylenically unsaturated groups and a specific photo-initiator to the photo-polymerization. This renders it possible to cure such compositions in a very short time and to improve quality and productivity with low operating and equipment costs.

Surface appearance-control and matting of UV-powder coatings and keeping these superior technology properties of the UV-coating are currently still difficult tasks.

The use of matting agents to adjust the matting effect to the desired level is well known, see WO 03/102048, U.S. Pat. No. 6,905,778 B2, EP-A 1129788 and EP-A 0947254. Such compositions often lead to coatings with a loss in technological properties, and additionally, they are often not suitable to provide coatings with specific surface properties, such as, scratch resistance and self-cleaning properties.

EP-A 772 514 and DE-A 102 49 453 disclose object surfaces having a specific structure consisting of elevations and depths with specific distances and heights, the elevations are made of hydrophobic polymers, for example, polymers with polyhedral silicone-oxygen units on their surface.

WO 02/064266 describes coatings providing a particle-based surface structure wherein the particles are from, e.g., metal oxides, silicates, sulfates, borates, metal powder, carbon black, organic polymers, such as, fluorine-containing polymers, having an average diameter of lower than 100 nm, and wherein the coating is at least partially hydrophobic.

However, these technical solutions are often difficult to control or inefficient.

### SUMMARY OF THE INVENTION

The invention relates to a process for the preparation of powder coatings with a controlled surface appearance comprising the following steps of:
a) applying a powder coating composition onto the substrate surface comprising 1 to 95 wt % of at least one hydrophobic agent based on the powder coating composition,
b) irradiating the applied powder coating composition with high energy radiation having a UV dose in a range of 100 to 5000 mJ/cm² under near-ambient temperature,
c) fusing, melting and flowing out the particles of the powder coating composition by increased temperature to a molten coating, and
d) curing the molten coating.

The process according to the invention makes it possible to provide coatings with a controlled surface appearance as well as to provide coatings having a high mechanical and outdoor stability. With the above described process, no change in formulation of the powder coating composition is necessary to achieve a desired surface appearance which means a desired gloss level as well as self-cleaning properties at the same time.

The desired surface appearance can be achieved by varying the time period and the intensity of the irradiation in step b) and/or the content of the hydrophobic agent in step a).

Hence, the technological properties of the cured coating, such as, abrasion, scratch and scuff resistance, leveling, chemical resistance and hardness remain at the original level.

Therefore, the substrates coated by the method according to the invention are especially suitable for the outdoor use.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference in their entirety.

The surface appearance of finishes prepared according to this invention is based on the surface structure of the coated substrate. This surface structure can be characterized by heights and depths on the coated surface provided by the invention wherein the distance between the heights may be in a range of 0.5 to 100 μm and the height may be in a range of 0.5 to 100 μm. Such kind of surface structure results in a range of gloss levels of the finishes.

The gloss of the finishes is measured at 60° according to DIN 67 530 and can be adjusted in the range of 1 to 95 by using the novel process. Typically, a matt finish has a gloss in the range of 1 to 20, and a low gloss finish in the range of 20 to 40.

The other part for providing a controlled surface appearance is the content of the hydrophobic agent in the powder coating composition of step a) to achieve a hydrophobic coating.

Both, the surface structure and the hydrophobic property of the coating produced by the method according to the invention provide a very high mechanical stability as well as the desired self-cleaning effect of the coating.

The present invention is based upon the process wherein the level of surface appearance of a powder coating can be controlled by varying the procedure of irradiation of the dry, applied powder coating composition with high energy radiation in step b).

In this step the irradiation is used under near-ambient temperature, that means, temperatures below the glass transition temperature of the coating, e.g., in the range of 0 to 60° C., preferable 15 to 30° C.

Following the irradiation with high energy in step b), the powder coating particles are fused, molten and flowed out by increased temperature. This can be done, e.g., by IR-radiation, IR-radiation combined with hot-air convection, or hot-air convection. IR radiation includes also Near-infrared radiation (NIR). Typically IR radiation uses wavelengths in the range of 0.76 μm to 1 mm and NIR radiation used wavelengths in the range of 0.76 to 1.2 μm. The melting temperature, for example, may be in the range of 60 to 250° C., measured as substrate surface temperature, and dependent on the kind of powder coating composition. Following step c) the molten powder coating is cured. This can be done by high energy radiation again. It is also possible to expose the applied and melted powder coating layer to thermal energy. The coating layer may, for example, be exposed by convective and/or radiant heating to temperatures of approximately 60 to 250° C., measured as substrate surface temperature, and dependent on the kind of powder coating composition. Exposing to thermal energy before, during and/or after irradiation with high energy radiation is also possible.

UV (ultraviolet)-radiation or electron beam radiation may be used as high-energy radiation. UV-radiation is preferred. Irradiation may proceed continuously or discontinuously, that means in cycles.

Irradiation may be carried out, for example, in a belt unit fitted with one or more UV-radiation emitters or with one or more UV-radiation emitters positioned in front of the object to be irradiated, or the area to be irradiated, or the substrate to be irradiated and/or the UV-radiation emitters are moved relative to one another during irradiation.

In principle the duration of irradiation distance from the object and/or radiation output of the UV-radiation emitter may be varied during UV irradiation. The preferred source of radiation comprises UV-radiation sources emitting in the wavelength range from 180 to 420 nm, in particular from 200 to 400 nm. Examples of such UV-radiation sources are optionally doped high, medium and low pressure mercury vapor emitters and gas discharged tubes, for such as, for example, low pressure xenon lamps. Apart from these continuously operating UV-radiation sources, however, it is also possible to use discontinuous UV-radiation sources. These are preferably so-called high-energy flash devices (UV-flash lamps for short). The UV-flash lamps may contain a plurality of flash tubes, for example, quartz tubes filled with inert gas, such as, xenon.

The distance between the UV-radiation sources and the substrate surface to be irradiated may be, for example, 0.5 to 300 cm.

Irradiation with UV-radiation may proceed in one or more irradiation steps. In other words, the energy to be applied by irradiation may be supplied completely in a single irradiation step or in portions in two or more irradiation steps.

UV doses of 100 to 5000 mJ/cm² are typical for curing the molten coating, preferred in a range of 1000 to 5000 mJ/cm².

For step b), the irradiation time with UV-radiation may be for example, in the range from 1 millisecond to 300 seconds, preferably from 0.1 to 60 seconds, depending on the number of flash discharges selected. If continuous UV-radiation sources are used, the irradiation time for step b) may be, for example, in the range from 0.5 seconds to 30 minutes, preferably less than 1 minute.

The UV dose, which is typically referred as the time integral of irradiance, is an important parameter that affects especially the irradiating efficiency in the step b). To achieve different surface appearance levels as desired the UV dose can be varied in the mentioned range. In this way it is possible to achieve matt powder coatings by pre-crosslinkage of the dry powder particles whereby the degree of pre-crosslinkage depends on the UV dose as well as also on the properties of the UV-curable powder coating composition. In principle, matt coatings are achieved by higher UV dose in step b) whereas higher gloss powder coatings are obtained by a lower UV dose in step b). The UV doses used in step b) of the process according to the invention are preferably in a range of 300 to 800 mJ/cm², especially preferred in a range of 300 to 500 mJ/cm².

The powder coating compositions of this invention contain 1 to 95 wt % of at least one hydrophobic agent. Preferred is a content in a range of 20 to 60 wt % based on the powder coating composition.

The hydrophobic agent is able to react with the functional groups of the resin components of the powder coating composition or, alternatively, the hydrophobic agent is able for self-crosslinking during curing.

Suitable hydrophobic agents are, for example, alkyl silanes, alkyl siloxanes and their oligomeres; fluorine-containing components, such as, perfluorinated hydro carbons, fluorine alkyl silanes and fluorine alkyl siloxanes and their oligomeres; which contains reactive groups, such as, e.g., alkoxy groups, OH-groups, SH-groups, vinyl groups, allyl groups, ester groups, ether groups, and epoxy groups.

The powder coating composition usable according to the invention contains one or more powder coating binders with ethylenically unsaturated groups. Suitable powder coating binders with ethylenically unsaturated groups are, for example, any powder coating binder known to the skilled person which can be crosslinked by free-radical polymerization. These powder coating binders can be prepolymers, such as, polymers and oligomers, containing, per molecule, one or more, free-radically polymerizable olefinic double bonds.

Examples of powder coating binders curable by free-radical polymerization include those based on epoxy, polyester, acrylic and/or urethane resins. Examples of such photopolymerizable resins include unsaturated polyesters, unsaturated (meth)acrylates, unsaturated polyester-urethanes, unsaturated (meth)acrylic-urethanes, unsaturated epoxides, unsaturated acrylated epoxies, unsaturated epoxy-polyesters, unsaturated polyester-acrylics, and unsaturated epoxy-acrylics.

(Meth)acrylic is respectively intended to mean acrylic and/or methacrylic.

In addition to the resins the powder coating compositions of this invention may contain additives that are conventional used in powder coating compositions. Examples of such additives include fillers, extenders, flow additives, photo-initiators, catalysts, hardeners, dyes and pigments. Compounds having anti-microbial activity may also be added to the powder coating compositions.

The powder coating compositions may contain photo-initiators in order to initiate the free-radical polymerization. Suitable photo-initiators include, for example, those which absorb in the wavelength range from 190 to 600 nm. Examples for photo-initiators for free-radically curing systems are benzoin and derivatives, acetophenone and derivatives, benzophenone and derivatives, thioxanthone and derivatives, anthraquinone, organo phosphorus compounds, such as, for example, acyl phosphine oxides.

The photo-initiators are used, for example, in quantities of 0.1 to 7 wt %, relative to the total of resin solids and photo-initiators. The photo-initiators may be used individually or in combination.

The powder coating compositions may comprise pigmented or unpigmented powder coating agents for producing any desired coating layer of a one-layer coating or a multilayer coating. The compositions may contain transparent, color-imparting and/or special effect-imparting pigments and/or extenders. Suitable color-imparting pigments are any conventional coating pigments of an organic or inorganic nature. Examples of inorganic or organic color-imparting pigments are titanium dioxide, micronized titanium dioxide, carbon black, azopigments, and phthalocyanine pigments. Examples of special effect-imparting pigments are metal pigments, for example, made from aluminum, copper or other metals, interference pigments, such as, metal oxide coated metal pigments and coated mica. Examples of usable extenders are silicon dioxide, aluminum silicate, barium sulfate, and calcium carbonate.

The additives are used in conventional amounts known to the person skilled in the art.

The powder coating composition may contain also further binder resins, such as, thermosetting resins, such as, in amounts of, e.g., 0 to 90 wt %, relative to the total resin solids, to make dual curing possible if desired. Such resins may be, for example, epoxy, polyester, (meth) acrylic and/or urethane resins.

The powder coating compositions are prepared by conventional manufacturing techniques used in the powder coating industry. For example, the ingredients used in the powder coating composition, can be blended together and heated to a temperature to melt the mixture and then the mixture is extruded. The extruded material is then cooled on chill roles, broken up and then ground to a fine powder, which can be classified to the desired grain size, for example, to an average particle size of 20 to 200 μm. The powder coating composition of this invention may be applied by electrostatic spraying, thermal or flame spraying, or fluidized bed coating methods, all of which are known to those skilled in the art. The coatings may be applied to metallic and/or non-metallic substrates or as a coating layer in a multi-layer film build.

In certain applications, the substrate to be coated may be pre-heated before the application of the powder, and then either heated after the application of the powder or not. For example, gas is commonly used for various heating steps, but other methods, e.g., microwaves, IR or NIR are also known. Also a primer can be applied, which seals the surface and provides the required electrical conductivity. UV-curable primers are also available.

Substrates, which may be considered, are metal, wooden substrates, wood fib material, paper or plastic parts, for example, also fibre-inforced plastic parts, for example, automotive and industrial bodies or body parts.

The process according to the invention provides coatings which a have a rough or textured surface microscopically which is seen as low gloss, but otherwise appears smooth to the naked eye.

The present invention is further defined in the following Examples. It should be understood that these Examples are given by way of illustration only. From the above discussion and these Examples, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth herein below, but rather is defined by the claims contained herein below.

The following Examples illustrate the invention. All parts and percentages are on a weight basis unless otherwise indicated.

### EXAMPLES

### Example UA1

### Manufacture of an Amorphous Urethane Acrylate UA1

In a three necked glass flask equipped with thermo couple, stirrer and dosing funnel 58.7 wt % of isophorone diisocyanate, 0.18 wt % of toluhydrochinone, 0.02% of dibutyl tindilaurate are loaded and heated to 65° C. 16.5 wt % of neopentylglycol are added while taking care that the temperature does not exceed 90° C. After dosing the mixture is heated to 100° C. and kept at that temperature till an NCO-value of below 11.8% is reached. 23.3 wt % of hydroxyethylacrylate are added at a temperature of 100-110° C. The reaction mixture is kept at 110° C. till an NCO-value of below 0.45% is reached. After that 1.3 wt % of hydroxybutylacrylate is added. The reaction mixture is kept at 110° C. till the NCO-value is below 0.1%. After filling out the resin solidifies to a transparent colorless amorphous resin.

### Example UA2

### Manufacture of a Siloxane Modified Urethane Acrylate UA2

A siloxane modified urethane acrylate is prepared by using the same procedure as described in UA1. The only difference is the molar exchange of neopentylglycol against a linear, telechelic α,ω-dihydroxy polydimethylsiloxane (Tegomer HSi-2111 from Tego).

### Example 1

### Manufacture of a Powder Coating According to the Invention

A clear coat composition is formulated by dry-mixing of 80 wt % of the amorphous urethane acrylate UA1, 1 wt % of Irgacure® 2959 (photo-initiator), 1 wt % of Tinuvin® 144 (UV absorber) and 18 wt % of siloxane modified urethane acrylate UA2. The coating formulation is charged into a twin screw extruder at a temperature setting of the extruder of 95 to 100° C. After extrusion, the melt is cooled down on a cooling belt and the resulted product is then crushing to small chips. The chips are milled to a suitable particle size distribution suitable for spraying, in a range of 20-80 μm.

Afterwards the powder is sprayed onto metal coil test panels with a tribo charge spray gun, to a film thickness of 80 to 90 μm.

The applied powder is irradiated, in a dry state, with a medium-pressure Mercury (Hg) lamp (Fusion 240 W/cm emitters), using UV dose of 500 mJ/cm².

After that, the melting of the irradiated powder is done with a combination of IR and convection heat to a substrate surface temperature of about 120 to 140° C. within a time range of about 4 minutes.

The curing of the melted coating occurs by UV irradiation with a medium pressure Gallium lamp (100 W/cm emitters, company IST). The UV dose for the curing step should be adjusted so the coating is fully cured; typically, with a UV dose of 3000 mJ/cm² or higher (measured from 200 to 390 nm wavelength).

### Example 2

### Manufacture of a Powder Coating Compositions According to Prior Art

The manufacture, application and curing process of the clear coat composition is the same as mentioned in Example 1, but without any hydrophobic agent UA2.

### Comparison of Example 1 and 2

Powder Coating Compositions according Example 1 and 2 both show a matt surface with a degree of gloss of 20% at 60°. They have been tested according their lotus effect. For that a defined amount of artificial dirt (cigarette ash) was applied on the coating, the coating is applied on an inclined plane and 10 ml of water droplets are applied on the coating. The visual amount of dirt that is staying on the coating is rated.

(0: no dirt left, 1: most dirt is removed, 2: high amount of dirt is removed, 3: low amount of dirt is removed, 4: no dirt is removed).

The test is performed before and after weathering test (1000 h CAM 180 artficial weathering test).

Test Results:

| | Dirt test before | Dirt test after |
|---|---|---|
| | weathering | weathering |
| Example 1 | 0 | 1 |
| Example 2 | 3 | 4 |

It can be seen from the test results that the lotus effect of the coatings based on the invention (Example 1) has better results before and after weathering than the coatings based on prior art (Example 2).

What is claimed is:

1. A process for the preparation of powder coatings with a controlled surface appearance comprising the following steps of
a) applying a powder coating composition onto the substrate surface comprising 1 to 95 wt % of at least one hydrophobic agent based on the powder coating composition,
b) irradiating the applied powder coating composition with high energy radiation having a UV dose in a range of 100 to 5000 mJ/cm² under near-ambient temperature,
c) fusing, melting and flowing out the particles of the powder coating composition by increased temperature to a molten coating, and
d) curing the molten coating.

2. The process according to claim 1 wherein the amount of the hydrophobic agent is in the range of 20 to 60 wt % based on the powder coating composition.

3. The process according to claim 2 wherein the hydrophobic agent is selected from the group consisting of alkyl silanes, alkyl siloxanes, their oligomeres, perfluorinated hydrocarbons, fluorine alkyl silanes, fluorine alkyl siloxanes and their oligomeres.

4. The process according to claim 3 wherein the powder coating composition comprises 20-60 wt %, based on the weight of the powder coating composition, of the hydrophobic agent and 40-80 wt %, based on the weight of the powder coating composition, of a photopolymerizable resin selected from the group consisting of unsaturated polyesters, unsaturated (meth)acrylates, unsaturated polyester-urethanes, unsaturated (meth)acrylic-urethanes, unsaturated epoxides, unsaturated acrylated epoxies, unsaturated epoxy-polyesters, unsaturated polyester-acrylics, and unsaturated epoxy-acrylics.

5. The process according to claim 1 wherein applied powder coating composition is irradiated in step b) with a UV dose in the range of 300 to 800 mJ/cm².

6. The process according to claim 2 wherein the irradiation time is in the range of 0.1 to 60 seconds.

7. The process according to claim 2 wherein the irradiation time is in the range of 0.5 seconds to 30 minutes.

8. The process according to claim 1 wherein the near-ambient temperature in step b) is in the range of 15 to 30° C.

9. The process according to claim 1 wherein the increased temperature in step c) is caused by techniques selected from the group consisting of IR-radiation and hot-air convection.

10. The process according to claim 1 wherein NIR radiation is used to increase temperature in step c).

11. The process according to claim 1 wherein the molten coating in step d) is cured by UV radiation.

12. A substrate surface coated by the process according to claim 1.

13. The substrate surface according to claim 12 wherein the substrate is pre-heated prior to applying the powder coating composition.
